(19) United States
(12) Patent Application Publication
(10) Pub. No.: US 2018/0318782 A1
(43) Pub. Date: Nov. 8, 2018

(54) Hydrogen Generator System

(71) Applicant: Intelligent Energy Limited, Loughborough (GB)

(72) Inventors: Andrew Paul KELLY, Loughborough, Leicestershire (GB); Ken WANG, Loughborough, Leicestershire (GB)

(73) Assignee: Intelligent Energy Limited, Loughborough (GB)

(21) Appl. No.: 15/772,462

(22) PCT Filed: Oct. 20, 2016
(86) PCT No.: PCT/GB2016/053281

§ 371 Date: Apr. 30, 2018

(30) Foreign Application Priority Data
Oct. 30, 2015 (GB) 1519250.3

(51) Int. Cl. B01J 7/02; C01B 3/06

(52) U.S. Cl. CPC B01J 7/02; C01B 3/065

(57) ABSTRACT

The disclosure relate to a hydrogen generator comprising a reactant cartridge and a reaction chamber. The reactant cartridge comprises a reactant reservoir comprising a first reactant for generating hydrogen gas; and an engagement mechanism configured to engage with a reaction chamber and enable the first reactant to pass from the reactant reservoir to the reaction chamber when the cartridge is engaged with the reaction chamber. The reaction chamber comprises: a reaction chamber for storing a second reactant; and an engagement mechanism configured to engage with the reactant cartridge and enable the first reactant to pass from the reactant cartridge to the reaction chamber when the cartridge is engaged with the reaction chamber.

The invention relates to a hydrogen generator, and in particular to a reactant cartridge and a reaction chamber for a hydrogen generator.

A fuel supply apparatus is useful for supplying hydrogen as fuel to hydrogen-consuming devices such as electrochemical fuel cells, which use the hydrogen to generate electrical power. It is desirable to have a safe and easily operable source of hydrogen.

A known type of fuel supply apparatus comprises a hydrogen generator that releases hydrogen on demand by the reaction of a reactant fuel material, such as a stabilized alkali metal material or chemical hydride, contained within a reaction chamber, with an activation fluid of aqueous solution or water supplied from a water chamber. As activation fluid is fed into the reaction chamber, hydrogen gas is generated and can be drawn off through an outlet for consumption by the fuel cell. For example, sodium borohydride (NaBH₄) can react with water to provide a high volume and flow rate of hydrogen gas suitable for a range of applications, including for electricity production in an unmanned aerial vehicle using an electrochemical fuel cell.

For some applications, such as providing a hydrogen generator for an unmanned aerial vehicle, it is desirable that the hydrogen generator should be lightweight and easy to store, ship and operate in a safe manner. In addition, minimising the number of components in the hydrogen generator is desirable in order to improve reliability and unit cost.

According to a first aspect of the invention there is provided a reactant cartridge for a hydrogen generator, the cartridge comprising:
a reactant reservoir comprising a reactant for generating hydrogen gas; and
an engagement mechanism configured to mechanically engage with a reaction chamber and enable the reactant to pass from the reactant reservoir to the reaction chamber when the cartridge is mechanically engaged with the reaction chamber.

The engagement mechanism may comprise a member configured to open a seal of the reaction chamber. The engagement mechanism may be configured to engage with an opening in the reaction chamber. The engagement mechanism may comprise a screw thread configured to engage with a mating screw thread of the reaction chamber. The engagement mechanism may comprise a locking member configured to engage with a respective locking member of the reaction chamber in order to secure the reactant cartridge to the reaction chamber. The locking members may have a snap fit relationship.

The reactant cartridge may comprise a sealing member for containing the reactant within the reactant reservoir, in which the sealing member is arranged to be opened by engagement of the reactant cartridge with the reaction chamber. The sealing member may be formed of a water soluble material

The reactant cartridge may be separable from the reaction chamber. The reactant cartridge may comprise a hydrogen flow path between a reaction chamber-facing portion of the reactant cartridge and an exterior of the reactant cartridge. A colour of the reactant cartridge may relate to a capacity of the reactant reservoir or a quantity of fuel within the reactant reservoir.

According to a further aspect of the invention there is provided a reaction chamber for a hydrogen generator, the reaction chamber comprising:
a reaction chamber for storing reactant; and
an engagement mechanism configured to mechanically engage with a reactant cartridge and enable the reactant to pass from the reactant cartridge to the reaction chamber when the cartridge is mechanically engaged with the reaction chamber.

The reaction chamber may comprise a reactant and a sealing member for containing the reactant within the reaction chamber. The sealing member may be arranged to be punctured or released by engagement of the reactant cartridge with the reaction chamber. The engagement mechanism may comprise an opening for receiving the reactant cartridge. The sealing member may be arranged to be opened by insertion of the reactant cartridge into the opening. The sealing member may be offset from the opening into the reaction chamber.

The engagement mechanism may comprise a screw thread configured to engage with a mating screw thread of the reactant cartridge. The engagement mechanism may comprise a member configured to open a seal of the reaction chamber. The engagement mechanism may comprise a locking member configured to engage with a respective locking member of the reactant cartridge in order to secure the reactant cartridge to the reaction chamber. The locking members have a snap fit relationship.

The reactant cartridge may be separable from the reaction chamber. The reaction chamber may comprise a hydrogen flow path for providing hydrogen gas generated in the reaction chamber.

According to a further aspect of the invention there is provided a neutraliser cartridge for engaging with the hydrogen flow path of the reactant cartridge or reaction chamber. The neutraliser cartridge may comprise a neutraliser reservoir. The neutraliser reservoir may comprise a chemical configured to neutralise a pH of the reactant for generating hydrogen gas. The neutraliser cartridge may comprise a delivery conduit configured to engage with the hydrogen flow path and deliver the chemical form the neutraliser reservoir to the reaction chamber through the hydrogen flow path.

According to a further aspect of the invention there is provided a fuel generator comprising the reactant cartridge and the reaction chamber. The reactant cartridge may be separable from the reaction chamber.

According to a further aspect of the invention there is provided a key for disengaging the reactant cartridge from the reaction chamber. The key may comprise a base and one or more pins that extend from the base. The one or more pins may be arranged, or shaped, to engage with the locking mechanisms of the reactant cartridge and the reaction chamber in order to disengage the locking mechanism of the reactant cartridge from the locking mechanism of the reaction chamber.

According to a further aspect of the invention there is provided a kit comprising a plurality of the reactant cartridges. The reactant reservoir of each reactant cartridge may be of a different capacity or may comprise a different amount of reactant. A colour of each of the reactant cartridges may relate to the quantity of fuel within that particular reactant cartridge.

According to a further aspect of the invention there is provided a method of assembling a hydrogen generator, comprising:
engaging a hydrogen cartridge comprising a first reactant with a reaction chamber comprising a second reactant;
reacting the first reactant with the second reactant to produce hydrogen gas; and
providing the hydrogen gas at a hydrogen gas outlet of the hydrogen generator.

Before engagement of the hydrogen cartridge with the reaction chamber, the reaction chamber may be sealed. A seal may be formed between the reactant cartridge and the reaction chamber. Passage of the first reactant from the reactant cartridge to the reaction chamber may be enabled.

According to a further aspect of the invention there is provided a method of recycling a hydrogen generator, comprising:
receiving a hydrogen generator comprising a reactant cartridge and a separable reaction chamber in which the reaction chamber comprises reactant by-product;
disengaging the reactant cartridge from the reaction chamber;
providing a first reactant in the reactant cartridge; and
sealing the reactant cartridge.

Although a hydrogen generator is described herein, it will be appreciated that a fuel generator may be provided using a reactant cartridge and reaction chamber as disclosed herein.

Embodiments of the present invention will now be described by way of example and with reference to the accompanying drawings in which:

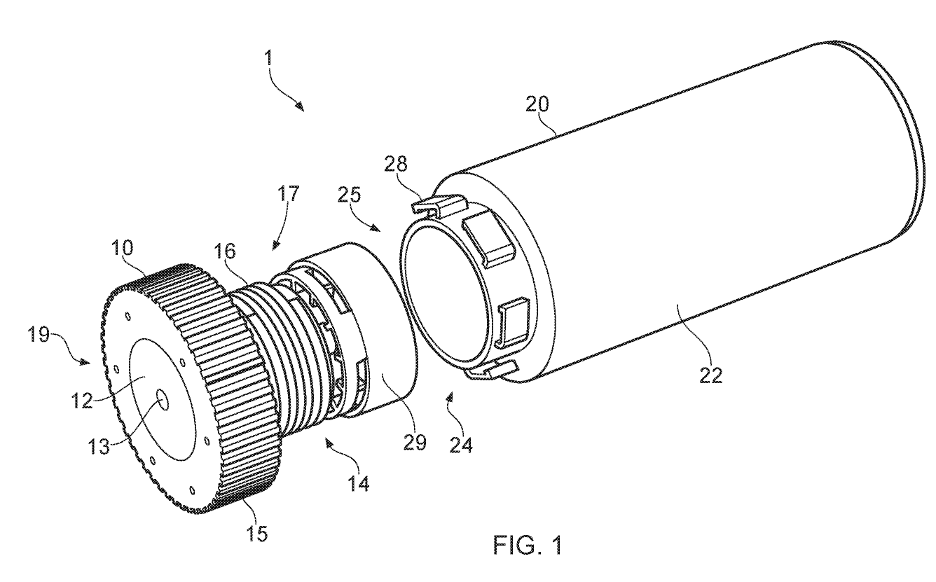

FIG. 1 illustrates an exploded perspective view of a hydrogen generator in a separated configuration;

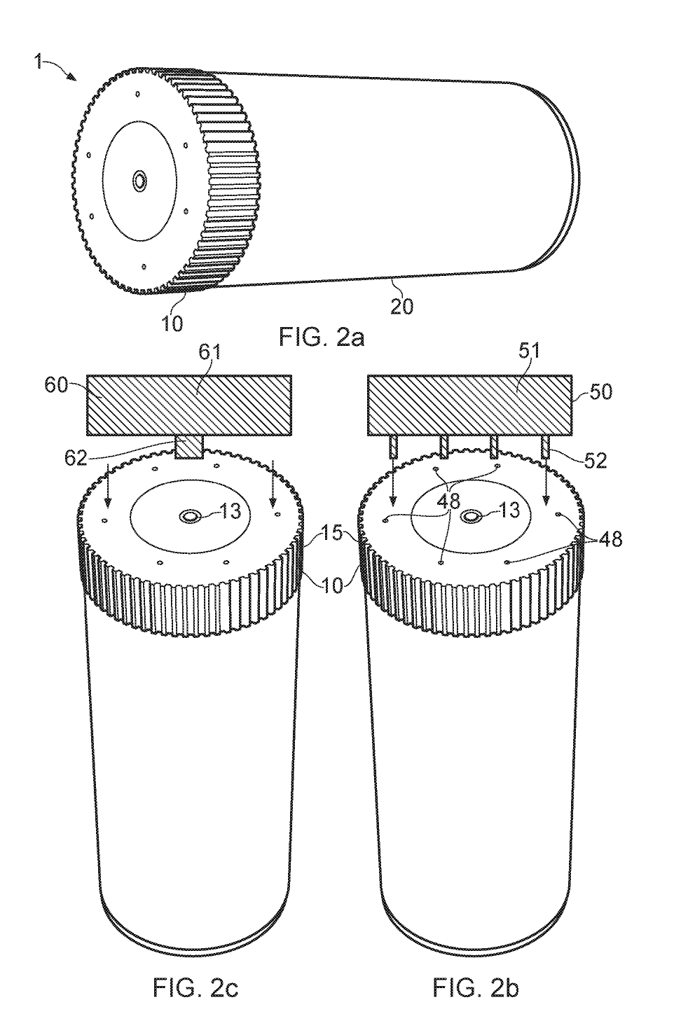

FIG. 2a illustrates a perspective view of a side of the hydrogen generator of FIG. 1 in an engaged configuration;

FIG. 2b illustrates the hydrogen generator of FIG. 2a and a side view of a key for unlocking the reactant cartridge from the reaction chamber;

FIG. 2c illustrates the hydrogen generator of FIG. 2a and a side view of a reactant neutralising cartridge;

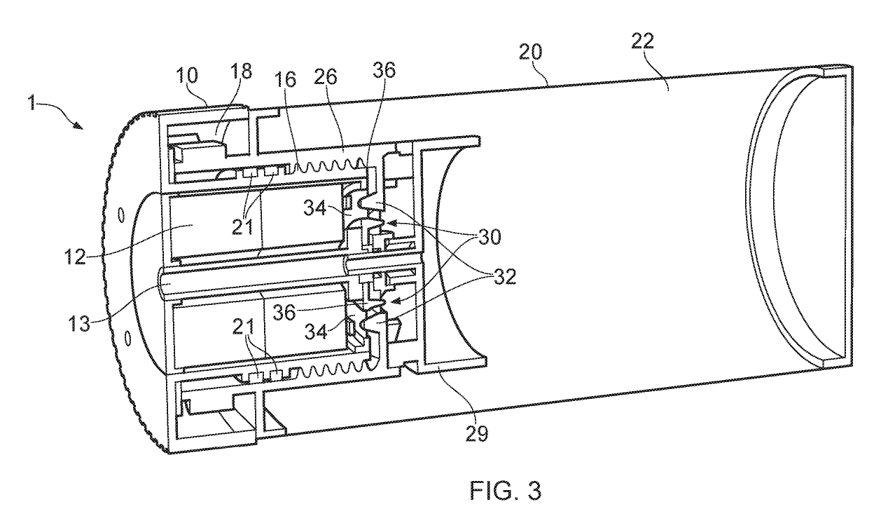

FIG. 3 illustrates a longitudinal cross section taken through the hydrogen generator of FIG. 2 in the engaged configuration;

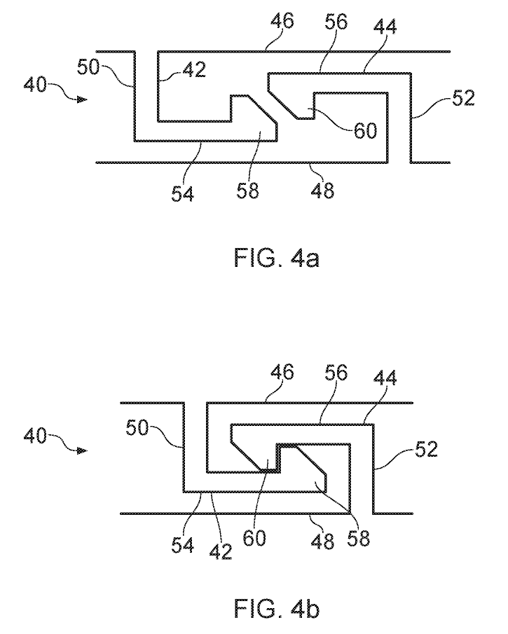

FIG. 4a illustrates a schematic cross section of a snap fit mechanism for a hydrogen generator in an unlocked configuration;

FIG. 4b illustrates a schematic cross section of the snap fit mechanism of FIG. 4a in a locked configuration;

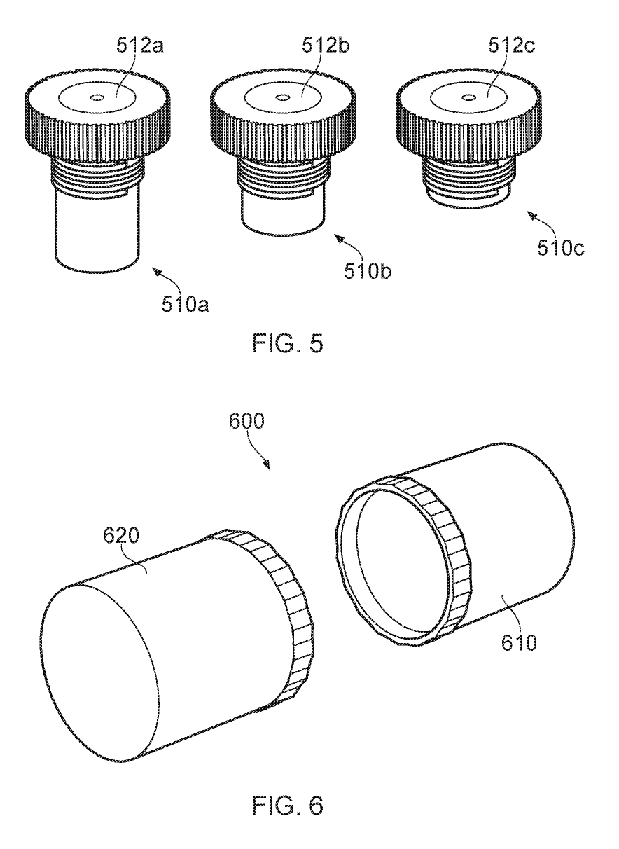

FIG. 5 illustrates reactant cartridges having reactant reservoirs of various different capacities;

FIG. 6 illustrates a perspective view of another hydrogen generator in a separated configuration;

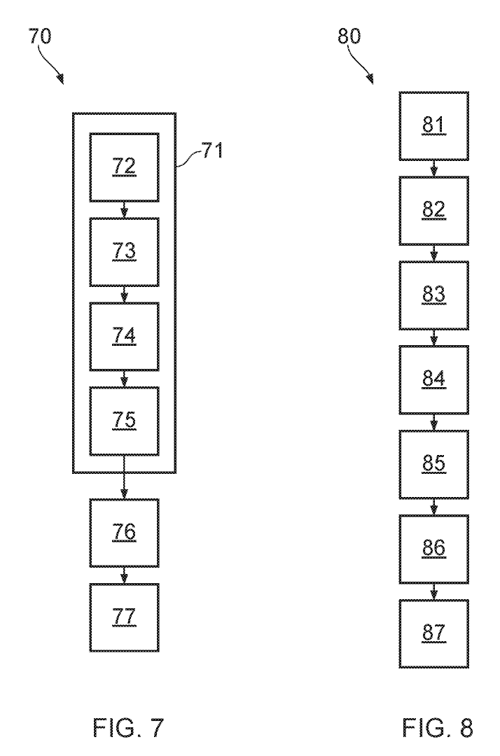

FIG. 7 illustrates a method of assembling a hydrogen generator to produce hydrogen gas; and

FIG. 8 illustrates a method of recycling a hydrogen generator.

The present disclosure provides a hydrogen generator comprising two parts, which may be stored and shipped separately in order for combining at the point of use. The two parts include a reaction chamber and a reactant cartridge for storing sodium borohydride (NaBH₄). Water may be sealed within the reaction chamber at the point of manufacture, for example. Alternatively, water may be added to the reaction chamber by a user shortly before initiation of the reaction. It may be preferable for water to the pre-sealed within the reaction chamber in order to ensure adequate water quality and sufficient water quantity.

A reactant flow path is automatically, and mechanically, opened between the reactant cartridge and the reaction chamber in response to the reactant cartridge mechanically engaging with the reaction chamber.

The two-part hydrogen generator provides a seal-and-break mechanism in which, at a first stage, a seal is formed between the respective components in order to safely retain the reactant within the hydrogen generator, and in which at a second stage, a seal between the reactant cartridge and the reaction chamber is broken to allow the reactants to mix. The reaction chamber may form a semi-permanent engagement with the reactant cartridge in order to safely retain the reaction and reaction by-products and so avoid injury to the user. The hydrogen generator may be considered to be single use because of the provision of the semi-permanent engagement of the reactant cartridge and the reaction chamber. The semi-permanent engagement may be defeated by application of appropriate tool in order to recondition the reactant cartridge and/or reaction chamber.

FIGS. 1 to 3 illustrate various views of a hydrogen generator 1 comprising a reactant cartridge 10 and a reaction chamber 20. FIG. 1 illustrates an exploded perspective view of the hydrogen generator 1 in a separated configuration in which the reactant cartridge 10 is detached from the reaction chamber 20. FIGS. 2a to 2c illustrate the hydrogen generator 1 in an engaged configuration in which the reactant cartridge 10 is connected to the reaction chamber 20. FIG. 3 illustrates a longitudinal cross section taken through the hydrogen generator 1 in the engaged configuration.

The reactant cartridge 10 comprises a reactant reservoir 12, which provides a container for a first reactant. The first reactant may be a liquid or solid in the form of a powder or pellets, for example. The reaction chamber 20 comprises a pressure vessel, or canister 22, with an opening 25 for receiving the reactant cartridge 10. A second reactant (not shown) may be provided within the reaction chamber 20. In one example, the first reactant may be a chemical hydride and the second reactant may be an aqueous solution or water. Sodium borohydride (NaBH₄) is an example of a chemical hydride that has been found to be suitable for producing hydrogen for fuel cell applications. The chemical hydride may be packaged in pellet or powder form within the reactant reservoir 12. Other examples of first reactants for use with an aqueous second reactant include other metal borohydrides, nano-silicon, aluminium and other metals made active for water splitting, lithium hydride, lithium aluminium hydride, sodium aluminium hydride, calcium hydride and sodium silicide. In other examples, a thermolysis fuel may be used in the hydrogen generator 1. Thermolysis fuels include ammonia borane, aluminium hydride (alane) and magnesium borohydride. There are also fuels that require the use of a reformer, such as methane or butane, for example.

The reactant cartridge 10 and reaction chamber 20 have corresponding engagement mechanisms 14, 24 with a number of components that together are configured to engage the reactant cartridge 10 with the reaction chamber 20 and enable the first reactant to pass from the reactant reservoir 12 to the reaction chamber 20 when the reactant cartridge 10 is engaged with the reaction chamber 20. The engagement mechanisms each have an engaged configuration in which the reactant cartridge is mechanically engaged to the reaction chamber and passage of reactant from the reactant reservoir to the reaction chamber is enabled. The engagement mechanisms also have a disengaged configuration in which the reactant cartridge is mechanically disengaged from the reaction chamber and reactant passage from the reactant reservoir to the reaction chamber is disabled. The reactant cartridge 10 may be separated, isolated, or physically disconnected, from the reaction chamber 20 in the disengaged configuration.

A handle 15 is provided on the reactant cartridge 10 to assist a user in rotating the reactant cartridge 10 with respect to the reaction chamber 20. The handle 15 encircles the reactant reservoir 12 in this example. A screw thread 26 is disposed on an inner surface of the reaction chamber 20 adjacent to the opening 25. A complementary screw thread 16 is provided on an outer surface of the reactant cartridge 10. The reactant cartridge 10 may be drawn into the reaction chamber 20 on mating of the screw threads 16, 26 and rotating the reactant cartridge 10 with respect to the reaction chamber 20.

A pair of gaskets, or O-rings 21, is positioned between the screw thread 16 of the reactant cartridge 10 and the handle 15. The pair of O-rings 21 is positioned to provide an airtight seal between the interior of the canister 22 and the exterior of the hydrogen generator 1 when the screw threads 16, 21 are mated together.

The reaction chamber 20 comprises a sacrificial seal 30 to retain the second reactant within the reaction chamber 20 when the hydrogen generator is in the separated configuration during storage, for example. In general, a sacrificial seal may be provided by a membrane, foil or film, which may comprise a metal or plastics material. The seal 30 is disposed in a seal housing 29 within the canister 22 longitudinally offset from the opening 25 at the end of travel of the screw thread 26. The seal housing 29 further comprises puncturing members 32 that protrude outwardly from the seal housing 29 towards the opening 25. In general, a puncturing member may be provided by a stud or sharp edge and may puncture a seal at a position where the puncturing member engages with the seal. Alternatively, a puncturing member may push a seal to cause it to become detached and open a reactant flow path.

The reactant cartridge 10 also comprises a sacrificial seal 34 to retain the first reactant within the reactant reservoir 12 when the hydrogen generator 1 is in the separated configuration. In the example illustrated in FIG. 3, the seal 34 is disposed at an offset position within reactant cartridge 10, adjacent to a reaction chamber-facing portion 17 of the reactant cartridge 10. The reaction chamber-facing portion 17 of the reactant cartridge 10 has puncturing members 36 that protrude outwardly from the reaction chamber-facing portion 17 of the reactant cartridge 10.

On insertion of the reactant cartridge 10 into the opening 25 of the reaction chamber 20, the O-rings 21 form a seal between the interior of the canister 22 and the exterior of the hydrogen generator 1. Subsequently, after rotation of the handle 15 with respect to the canister 22, the screw threads 16, 26 are mated and the reaction cartridge 10 is drawn into the opening 25 of the reaction chamber 20. Locking members 18, 28 secure the reactant cartridge 10 to the reaction chamber 20 following rotational engagement of the reactant cartridge 10 and the reaction chamber 20. Towards the end of the travel of the screw threads, 16, 26, firstly, the puncturing members 32 of the reaction chamber 20 contact and open the sacrificial seal 34 of the reactant cartridge 10 and, secondly, the puncturing members 36 of the reactant cartridge 10 contact and open the sacrificial seal 30 of the reaction chamber 20. In this way the puncturing members 32, 36 open the respective seals 30, 34 and provide a reactant flow path between the first reactant in the reactant reservoir 12 and the second reactant in the reaction chamber 20. In this way, the control of the reactant flow path is purely mechanical and does not require any electronic control system and so the cost, weight and complexity of the hydrogen generator may be reduced. It is preferable for the locking members 18, 28 to secure the reactant cartridge 10 to the reaction chamber 20 before the initiation of the reaction in order to improve user safety.

In an alternative example, the reaction chamber 20 may be provided without puncturing members 32 and the sacrificial seal 34 of the reactant cartridge 10 may be formed of a water soluble material so that the seal 34 is dissolved following engagement of the reaction chamber 20 with the reactant cartridge 10.

Optionally, the reactant flow path may comprise a valve configured to prevent the passage of reactant between the reactant cartridge 10 and the reaction chamber 20 in response to a pressure build-up in the reaction chamber 20. In this way, further reaction can be curtailed in response to a pressure increase within the reaction chamber 20 in order to prevent excess pressure condition. The provision of such a valve may therefore improve the safety of the hydrogen generator.

A hydrogen flow path 13 provides an outlet for hydrogen gas generated within the reaction chamber 20. The hydrogen flow path 13 has a first part that is provided through the reactant cartridge 10 between a reaction chamber-facing portion 17 of the reactant cartridge 10 and an exterior face 19 of the reactant cartridge 10. The first part of the hydrogen flow path 13 may be provided by a conduit that is open respective of whether the reactant cartridge 10 is engaged with the reaction chamber 20. The hydrogen flow path 13 may have a second part that extends through the seal housing 29 of the reaction chamber 20 and is configured to engage with the first part of the hydrogen flow path 13 when the reactant cartridge 10 engages with the reaction chamber 20. The second part of the hydrogen flow path 13 may have a seal to retain the second reactant within the reaction chamber during storage. The seal may be opened by engagement of the second part of the hydrogen flow path 13 with the first part of the hydrogen flow path 13. A ball valve or quick connect dry coupling, for example, may provide the seal in the second part of the hydrogen flow path 13. Alternatively, a hydrogen flow path may be provided by the reaction chamber 20 itself as a flow path through a wall of the canister 22.

In this example, the locking members 18, 28 provide a ratchet and pawl arrangement. A locking member 18 is provided within the handle 15 of the reactant cartridge 10. The locking member 18 comprises inward-facing teeth of the ratchet provided on an inner surface of the handle 15. A corresponding locking member 28 is provided on an external surface of the reaction chamber 20. The corresponding locking member 28 provides a series of pawls that engage with the ratchet. The pawls pass over the ratchet during rotation of the handle 15 with respect to the reaction chamber 20 during insertion of the reactant cartridge 10 into the reaction chamber 20. However, the pawls oppose reverse rotation of the handle 15 with respect to the reaction chamber 20 and prevents the reactant cartridge 10 from being withdrawn from the reaction chamber 20. The engagement of the pawl with the ratchet can be considered to provide a snap fit relationship.

In some examples, the snap fit mechanism may provide a permanent engagement between the reactant cartridge 10 and the reaction chamber 20. This is advantageous because it prevents the release of potentially dangerous reactants into the environment and so improve the safety of the hydrogen generator 1.

FIGS. 4a and 4b illustrates a schematic cross section of another snap fit mechanism 40 for a hydrogen generator. FIG. 4a illustrates an unlocked configuration and FIG. 4b illustrates a locked configuration of the snap fit mechanism 40.

The snap fit mechanism 40 comprises a first clip, or first locking member 42, and a second clip, or second locking member 44. The first locking member 42 extends from a reactant cartridge surface 46 and the second locking member 44 extends from a reaction chamber surface 48. The reactant cartridge surface 46 faces the reaction chamber surface 48 in both the locked and unlocked configurations. The reactant cartridge surface 46 may be provided adjacent to a screw thread of the reactant cartridge with the first locking member 42 extending along an axis of the screw thread. The reaction chamber surface 48 may be provided on an inner surface of the reaction chamber with the second locking member 44 extending longitudinally (along the axis of the screw thread) towards an opening of the reaction chamber in order to face the first locking member 42 when the reactant cartridge is inserted into the opening.

Each locking member 42, 44 comprises a support 50, 52 extending away from the respective surface 46, 48. Flexible portions 54, 56 extend along the surfaces 46, 48. A first end of each of the flexible portions 54, 56 is connected to the respective supports 50, 52 such that the flexible portions 54, 56 are offset from the surfaces 46, 48 by the supports 50, 52. Projections, or detents 58, 60, extend from a second end of the flexible portions 54, 56 towards a respective surface 46, 48. The detents 54, 60 have a leading-edge and the trailing edge with respect to an engagement direction. The leading-edge is curved for bevelled in order to assist engagement whereas the trailing edge provides a barrier to disengagement.

In the unlocked configuration shown in FIG. 4a, the leading-edge of the detent 58 of the first locking member 42 is facing the leading-edge of the detent 60 of the second locking member 44. The locking members 42, 44 may be engaged by moving the first member 42 towards the second member 44 such that the leading edges of the detents 58, 60 come into contact and slide over one another. During the sliding action the flexible portions are resiliently deformed so that the detent 58 of the first locking member 42 is pushed towards the reaction chamber surface 48 and the detent 60 of the second locking member 44 is pushed towards the reactant cartridge surface 46. Once the detents 58, 60 have slide over one another the flexible portions 54, 56 are return to an unstressed configuration and a snap fit is formed.

In the locked configuration shown in FIG. 4b, the locking members 42, 44 are interlocked after the forming of the snap fit. The locking members 42, 44 cannot be disengaged from one another by forcing the locking members 42, 44 apart along the direction of the surfaces because the trailing edges of the detents 58, 60 abut one another.

Returning to FIG. 2b, a key 50 for unlocking the reactant cartridge 10 from the reaction chamber 20 is provided. The key comprises a base 51 and a plurality of pins 52 that extend from the base 51.

A series of holes 48 is provided on the handle 15 of the reactant cartridge 10. The series of holes 48 is arranged such that each hole corresponds with one of the pins 52 of the key 50 and with a member of the locking mechanisms of the reactant cartridge 10 or reactant chamber 20. In this way, the pins 52 of the key 50 can be pushed or otherwise inserted through the holes 48 and contact the locking mechanisms of the reactant cartridge 10 and the reactant chamber 20 in order to disengage the locking mechanism of the reactant cartridge 10 from the locking mechanism of the reaction chamber 20. Once the locking mechanisms are disengaged, the reactant cartridge 10 may be rotated with respect to the reaction chamber 20 in order to disengage the respective screw threads 16, 26 of the reactant cartridge 10 and the reaction chamber 20 (as described above with reference to FIGS. 1 and 3). The key 50 therefore provides an unlocking mechanism in order to release the reactant cartridge 10 from the reaction chamber 20 once the reaction has completed. The hydrogen generator 1 may therefore be recyclable and can be serviced by qualified personnel using the key 50 whilst protecting regular users from inadvertently releasing reactant or reaction by-product.

FIG. 2c illustrates the hydrogen generator of FIG. 2a and a side view of a reactant neutralising cartridge 60. The reactant neutralising cartridge 60 has a base 61 that contains a neutraliser reservoir. A chemical configured to neutralise a pH of a reactant for generating hydrogen gas is contained within the neutraliser reservoir. For example, where the first reactant from the reactant cartridge 10 is an alkali reactant, such as sodium borohydride, the chemical may be provided by an acid such as hydrochloric acid in order to neutralise the alkali reactant.

The neutralising cartridge 60 also comprises a delivery conduit 62 that is in fluid communication with the neutralising reservoir. The delivery conduit 62 may be configured to engage with the hydrogen flow path 13 of the reactant cartridge 10 in a similar way that a hydrogen consuming device, such as a fuel cell, may be attached to the hydrogen flow path 13. A ball valve or quick connect dry coupling, for example, may provide a valve or seal in the delivery conduit 62 in order to seal the neutralising reservoir when the neutralising cartridge 60 is not in use. On engagement of the neutralising cartridge 60 and the hydrogen flow path 13, the seal in the delivery conduit 62 is opened in order to deliver the chemical from the neutraliser reservoir to the reaction chamber 20 through the hydrogen flow path 13. In this way, the neutralising cartridge 60 may be used to neutralise unspent reactant within the reaction chamber 20. A pH monitor may be provided by any means known in the art in order to provide an indication of the pH in the reaction chamber 20 and so guide a user as to whether the reaction is fully spent and whether the application of the neutralising cartridge 60 is required. The pH monitor may also be used in order to determine when the unspent reactant in the reaction chamber 20 has been neutralised such that the neutralising cartridge 60 should be disengaged.

FIG. 5 illustrates reactant cartridges 510a-c with reactant reservoirs 512a-c of various different capacities. The capacity of a particular reactant reservoir 512a-c affects the maximum hydrogen gas volume that may be produced by that fuel cartridge for a given type of reactant. In vehicular applications, the maximum hydrogen gas volume that may be produced by the reactant cartridge places a limit on the operating distance and/or operating duration of the vehicle. In order to assist a user in selecting an appropriate reactant cartridge for a particular journey, the reactant cartridges may be colour-coded in order to indicate an expected operating distance/duration associated with the cartridge. For example, the largest cartridge 510a shown in FIG. 5 may be coloured red to indicate an expected operating period of 60 minutes, the medium sized cartridge 510b may be coloured orange to indicate an expected operating period of 40 minutes and the smallest cartridge 510c may be coloured blue to indicate an expected operating period of 20 minutes.

FIG. 6 illustrates another hydrogen generator 600 similar to that described with reference to FIGS. 1 to 3. The hydrogen generator 600 has a reactant cartridge 610 and a reaction chamber 620. The reactant cartridge 610 and the reaction chamber 620 each have engagement mechanisms that perform similar functions to those described previously. However, in this example the engagement mechanism of the reactant cartridge 610 has an identical arrangement to the engagement mechanism of the reaction chamber 620.

In examples in which an unsealed reaction chamber is provided in order for the user to add their own water, markings may be provided on an inner surface of the reaction chamber in order to provide a guide for how much water is required for a corresponding reactant cartridge. Alternatively, bungs or floats may be provided for insertion into the reaction chamber in order to occupy space that is not required for water when using the reaction chamber with a particular reactant cartridge. For example, a bung or float of a suitable size may be provided for use with a particular reactant cartridge.

FIG. 7 illustrates a method 70 of assembling a hydrogen generator to produce hydrogen gas. The method 70 comprises:
engaging 71 a hydrogen cartridge comprising a first reactant with a reaction chamber (which may be sealed) comprising a second reactant;
reacting 76 the first reactant with the second reactant to produce hydrogen gas; and
providing 77 the hydrogen gas at a hydrogen gas outlet of the hydrogen generator.

The step of engaging the hydrogen cartridge with the reaction chamber may comprise a number of optional steps, including:
forming a seal between the reactant cartridge and the reaction chamber, which may further include one or more of:
   engaging 72 a screw thread of the reactant cartridge with a corresponding screw thread of the reaction chamber;
   rotating 73 the reactant cartridge with respect to the reaction chamber in order to draw the hydrogen cartridge into the reaction chamber; and
   locking 74 the reactant cartridge to the reaction chamber in order to prevent decoupling of the reactant cartridge from the reaction chamber, and
enabling 75 the passage of the first reactant from the reactant cartridge to the reaction chamber by, for example, piercing or releasing a seal of the reaction chamber and/or piercing or releasing a seal of the reactant cartridge.

The steps 71-77 of the method 70 may be performed in a different order to that illustrated in FIG. 7. In particular, the order of the above optional steps 72-75 of the method 70 may vary depending upon the particular arrangement of the hydrogen generator.

FIG. 8 illustrates a method 80 of recycling a hydrogen generator. The method 80 comprises:
receiving 81 a hydrogen generator comprising a reactant cartridge and a separable reaction chamber in which the reaction chamber comprises reactant by-product;
disengaging 82 the reactant cartridge from the reaction chamber;
providing 84 a first reactant in the reactant cartridge; and
sealing 87 the reactant cartridge.

The method 80 may also comprise one or more of the following optional steps:
cleaning 83 the reactant cartridge and/or reaction chamber;
providing 85 a second reactant in the reaction chamber; and
sealing 86 the reaction chamber.

The steps 81-87 of the method 80 may be performed in a different order to that illustrated in FIG. 8.

Although various examples are given above in order to exemplify the invention, it will be apparent to the skilled person that various modifications may be made. For example, the engagement mechanism for mechanically connecting the reactant cartridge to the reaction chamber may comprise a quarter turn, half turn or linear push arrangement.

In some examples, a mixture comprising the first and second reactants may be provided together within one of the reactant cartridge and the reaction chamber. The other of the reactant cartridge and the reactant chamber may comprise a catalyst for catalysing a reaction between the first reactant and the second reactant. A rate of reaction between the first reactant and the second reactant may be low or insignificant until the mixture of the first and second reactants is brought into contact with the catalyst. The catalyst may be provided by a metal in the form of a powder, for example. Various catalysts for catalysing a reaction between sodium borohydride and water are known in the art. For example, ruthenium, rhodium, nickel, cobalt or platinum may be used to catalyse a reaction between a chemical hydride and an aqueous solution. A reaction inhibitor may be provided in the mixture in order to inhibit the reaction in the absence of the catalyst. Sodium hydroxide is an example of a reaction inhibitor for a reaction between sodium borohydride and water.

Other embodiments are intentionally within the scope of the accompanying claims.

1. A reactant cartridge for a hydrogen generator, the cartridge comprising:
a reactant reservoir comprising a reactant for generating hydrogen gas; and
an engagement mechanism configured to mechanically engage with a reaction chamber and enable the reactant to pass from the reactant reservoir to the reaction chamber when the cartridge is mechanically engaged with the reaction chamber.

2. (canceled)

3. The reactant cartridge of claim 1 in which the engagement mechanism is configured to engage with an opening in the reaction chamber.

4. The reactant cartridge of claim 3 in which the engagement mechanism comprises a screw thread configured to engage with a mating screw thread of the reaction chamber.

5. The reactant cartridge of claim 3 in which the engagement mechanism comprises a locking member configured to engage with a respective locking member of the reaction chamber in order to secure the reactant cartridge to the reaction chamber.

6. The reactant cartridge of claim 5 in which the locking members have a snap fit relationship.

7. The reactant cartridge of claim 1 comprising: a sealing member for containing the reactant within the reactant reservoir, in which the sealing member is arranged to be opened by engagement of the reactant cartridge with the reaction chamber; and,
wherein the sealing member is formed of a water soluble material.

8.-10. (canceled)

11. The reactant cartridge of claim 1 in which a color of the reactant cartridge relates to a capacity of the reactant reservoir or a quantity of fuel within the reactant reservoir.

12. A reaction chamber for a hydrogen generator, the reaction chamber comprising:
a reaction chamber for storing reactant;
an engagement mechanism configured to mechanically engage with a reactant cartridge and enable the reactant to pass from the reactant cartridge to the reaction chamber when the cartridge is mechanically engaged with the reaction chamber; and,
a reactant and a sealing member for containing the reactant within the reaction chamber, in which the sealing member is arranged to be punctured or released by engagement of the reactant cartridge with the reaction chamber.

13-17. (canceled)

18. The reaction chamber of claim 12 in which the engagement mechanism comprises a locking member configured to engage with a respective locking member of the reactant cartridge in order to secure the reactant cartridge to the reaction chamber.

19. The reaction chamber of claim 18 in which the locking members have a snap fit relationship.

20. The reaction chamber of claim 12 in which the reactant cartridge is separable from the reaction chamber.

21. (canceled)

22. The reactant cartridge of claim 10 further comprising a neutraliser cartridge for engaging with the hydrogen flow path:
a neutraliser reservoir comprising a chemical configured to neutralise a pH of the reactant for generating hydrogen gas; and,
a delivery conduit configured to engage with the hydrogen flow path and deliver the chemical form the neutraliser reservoir to the reaction chamber through the hydrogen flow path.

23-24. (canceled)

25. A key for disengaging the reactant cartridge of claim 6 from the reaction chamber of claim 19, comprising a base and one or more pins that extend from the base, in which the one or more pins are arranged to engage with the locking mechanisms of the reactant cartridge and the reaction chamber in order to disengage the locking mechanism of the reactant cartridge from the locking mechanism of the reaction chamber.

26. A kit comprising a plurality of the reactant cartridges of claim 1, in which the reactant reservoir of each reactant cartridge is of a different capacity or comprises a different amount of reactant.

27. The kit of claim 26 in which a color of each of the reactant cartridges relate to the quantity of fuel within that particular reactant cartridge.

28. A method of assembling a hydrogen generator, comprising:
engaging a hydrogen cartridge comprising a first reactant with a reaction chamber comprising a second reactant;
reacting the first reactant with the second reactant to produce hydrogen gas; and
providing the hydrogen gas at a hydrogen gas outlet of the hydrogen generator.

29. The method of claim 28 in which the reaction chamber is initially a sealed reaction chamber.

30. The method of claim 28, comprising:
forming a seal between the reactant cartridge and the reaction chamber; and
enabling the passage of the first reactant from the reactant cartridge to the reaction chamber.

31. A method of recycling a hydrogen generator, comprising:
receiving a hydrogen generator comprising a reactant cartridge and a separable reaction chamber in which the reaction chamber comprises reactant by-product;
disengaging the reactant cartridge from the reaction chamber;
providing a first reactant in the reactant cartridge; and
sealing the reactant cartridge.

32. (canceled)
